(19) United States
(12) Patent Application Publication
(10) Pub. No.: US 2009/0235636 A1
(43) Pub. Date: Sep. 24, 2009

(54) Reinforced, regeneratively cooled uni-body rocket engine

(76) Inventor: Robert Oehrlein, Fairfax Station, VA (US)

Correspondence Address: Dennis H. Lambert, 7000 View Park Drive, Burke, VA, 22015, US

(21) Appl. No.: 12/077,758

(22) Filed: Mar. 21, 2008

(51) Int. Cl. F02K 9/00

(52) U.S. Cl. 60/200.1

(57) ABSTRACT

A rocket engine having a combustion chamber, a throat, and an exhaust bell is made with spaced apart inner and outer skins each unitarily formed in one piece of carbon fiber fabric. Longitudinal ribs in the space between the skins reinforce the engine and divide the space into a plurality of flow channels. An oxidizer ring at the bottom of the exhaust bell is in fluid flow communication with the flow channels, and one or more oxidizer tubes are connected tangentially at one end to the ring to supply oxidizer to the ring and thence to the flow channels. The oxidizer tubes are connected at their other end to the engine above the throat, further reinforcing the engine. An igniter is in the combustion chamber, and ignition fuel ports are directed toward the igniter to provide a soft start ignition.

### TECHNICAL FIELD

This invention relates generally to rocket engines, and more particularly to a reinforced, regeneratively cooled, uni-body rocket engine with a soft-start ignition.

### BACKGROUND ART

Conventional rockets take off vertically and use a propellant that is a chemical mixture of fuel and oxidizer burned to produce thrust. The single heaviest item carried by a spaceship is the propellant, of which the oxidizer comprises the majority.

The greatest rate of oxygen consumption for a rocket engine is relatively close to the ground, where atmospheric air up to about 40,000 feet contains a relatively large amount of oxygen. In spite of the presence of oxygen at low altitudes, conventional space ships, regardless of the type of propellant they burn, carry the required oxygen on-board, adding significantly to the mass of the spaceship.

In liquid propellant rockets the fuel and oxidizer are stored in separate tanks and fed through a system of pipes, valves, and pumps to a combustion chamber where they are combined and burned to produce thrust. Liquid propellant engines are more complex than solid propellant motors, but they offer several advantages. By controlling the flow of propellant to the combustion chamber, the engine can be throttled, stopped, or restarted. Liquid propellants used in rocketry can be classified into three types: petroleum, cryogens, and hypergols. One petroleum-based fuel commonly used in rocket engines is a type of highly refined kerosene called RP-1 in the United States. Petroleum fuels are commonly used in combination with liquid oxygen as the oxidizer. Liquid oxygen requires thermal insulation and increases the mass of the launcher. Cryogenic propellants are liquefied gases stored at very low temperatures, and most frequently comprise liquid hydrogen (LH₂) as the fuel and liquid oxygen (LO₂ or LOX) as the oxidizer. Because of the low temperatures of cryogenic propellants they require thermal insulation and are difficult to store over long periods of time. They also require a storage volume many times greater than other fuels, increasing the mass of the launcher.

Further, conventional space ships do not provide any means for propulsion upon return to earth, when all the fuel is used up. For example, upon its return to earth the space shuttle functions essentially as a glider that must make a successful landing on the first pass.

To ignite the fuel and oxidizer mixture of a typical rocket engine, including the engines of the space shuttle, a shower of sparks is directed at the base of the engine into the explosive mixture of fuel and oxidizer being emitted from the engine. Prior to ignition, this explosive mixture fills the combustion chamber, the throat, the exhaust bell, and the space between the bell and the ground. When the shower of sparks touches the fuel-oxidizer mixture, there is a sudden all-over ignition. This is called a hard start and is dangerous and stressful on the equipment.

Conventional rocket engines are typically made of metal, with multiple pieces welded together to form the combustion chamber, throat, and exhaust nozzle or bell, leading to manufacturing complexities and increased cost, with potential failure points.

One known example of a regeneratively cooled rocket engine currently under development is made of welded-together pieces of metal, forming a combustion chamber, throat, and exhaust bell with spaced apart inner and outer skins. Oxidizer is supplied through an oxidizer tube to an oxidizer ring at the bottom end of the exhaust bell and then upwardly between the skins to the upper end of the combustion chamber. Only a single tube is provided, attached perpendicularly to the ring, and attached to the engine only at the ring.

Liquid-fuel rocket engines typically have a fuel plate assembly at the top of the combustion chamber, with the fuel plate manifold on the outside of the combustion chamber above the bolting flange, resembling a flat rim hat, with the top of the hat extending above and outside the combustion chamber. Further, conventional fuel plates for supplying oxidizer and fuel to the combustion chamber have a plurality of holes formed in them extending vertically through the plate.

The future of space travel and space tourism would benefit from space planes that take off horizontally from an airport, like a conventional airplane, using forward momentum to create lift on the wings. Some of the relatively new space tourism space planes currently under development are designed to take off horizontally, like conventional airplanes, and accordingly would spend more time in the lower altitudes than rockets that launch vertically, and could take advantage of the relatively oxygen-rich atmosphere up to about 40,000 feet. These engines also can be reignited for landing. However, current designs of these newer space tourism planes carry twin turbo fan engines for take-off and landing, and a rocket engine for use at higher altitudes. The use of two extra engines for take off and landing adds significantly to the mass of the space plane.

It would be advantageous to have a rocket engine that uses outside air at altitudes up to about 40,000 feet, then blends on-board oxidizer with the outside air up to about 100,000 feet, and then uses stored oxidizer alone. This would eliminate the need for the two turbofan engines and their attendant weight currently proposed for use at lower altitudes in conventional space plane designs.

It would also be advantageous to have a rocket engine of uni-body design to eliminate potential points of weakness resulting from welded together pieces of metal as in conventional rocket engines. In particular, it would be desirable to have a uni-body rocket engine made of Kevlar-reinforced carbon fiber skins.

It would be advantageous in a Kevlar-reinforced uni-body construction to have spaced apart longitudinally extending ribs bonded to and between the skins to form channels for flow of the oxidizer and to reinforce the uni-body construction from one end of the engine to the other.

Further, it would be advantageous to have a regeneratively cooled rocket engine in which the oxidizer tubes are attached to the oxidizer ring at the bottom of the exhaust nozzle and to the combustion chamber above the throat, thereby further reinforcing the engine, especially across the throat, its narrowest and potentially weakest point.

It would further be advantageous to connect the lower end of the oxidizer tube to the oxidizer ring in a generally tangential direction for improved flow, and to use multiple oxidizer tubes for more efficient and uniform distribution of the oxidizer in the flow channels between the skins of the uni-body and to enable supply of multiple types of oxidizer from different sources.

It would also be advantageous to have the fuel plate assembly designed so that the fuel plate manifold is oriented downwardly and extends into the upper end of the combustion chamber, enabling the oxidizer to flow into the manifold from the sides.

It would further be advantageous to have a fuel plate wherein the plurality of holes for supplying oxidizer and fuel to the combustion chamber extend at an angle through the plate to produce a swirling or vortex action in the combustion chamber.

It would also be advantageous to have, in addition to the main fuel supply, individually controlled auxiliary fuel supply tubes connected with the fuel plate assembly to supply more fuel to selected parts of the fuel plate manifold when desired for extra boost, and/or to supply different fuel or fuels.

A further advantage would be to have an ignition system that directs a relatively small amount of fuel toward one or more igniters to initiate combustion, resulting in a “soft start”, rather than to completely fill the combustion chamber, throat and nozzle before igniting the fuel and oxidizer mixture as in conventional designs, a so-called “hard start”.

A still further advantage would be to have multiple igniters to provide a redundant ignition in the event of failure of one igniter.

Another advantage would be to have one or more annular shoulders in the exhaust bell, facing axially outwardly thereof, to provide reaction surfaces for developing added thrust in the exhaust bell.

### SUMMARY OF THE INVENTION

The rocket engine according to the present invention uses outside air at altitudes up to about 40,000 feet, then blends on-board oxidizer with the outside air up to about 100,000 feet, and then uses on-board oxidizer alone, thus enabling use of a single type of engine operable at all altitudes, rather than requiring use of a first engine type that uses outside air at lower altitudes and a second engine type that uses on-board oxidizer at higher altitudes.

The rocket engine of the invention is of uni-body construction, thereby eliminating potential points of weakness that can result from welded together pieces of metal as in conventional rocket engines. In particular, the engine of the invention is made of Kevlar-reinforced carbon fiber skins, with spaced apart longitudinally extending ceramic ribs bonded to and between the skins to form channels for flow of the oxidizer and to reinforce the uni-body construction from one end of the engine to the other.

The engine of the invention is regeneratively cooled and has one or more oxidizer tubes connected between a source of oxidizer and an oxidizer ring at the bottom of the exhaust nozzle. The tubes are attached to the oxidizer ring and to the combustion chamber, in spanning relationship to the throat, and in addition to supplying oxidizer also reinforce the engine, especially across the throat, its narrowest and potentially weakest point.

In the engine of the invention the lower end of the oxidizer tube is connected to the oxidizer ring in a generally tangential direction for improved flow, and in preferred embodiments multiple oxidizer tubes are used for more efficient and uniform distribution of the oxidizer in the flow channels between the skins of the uni-body and to enable supply of multiple types of oxidizer from different sources.

The fuel plate assembly in the engine of the invention is designed so that the fuel plate manifold is oriented downwardly and extends into the upper end of the combustion chamber, enabling the oxidizer to flow into the manifold from the sides.

Further, in one embodiment of the present invention the plurality of holes in the fuel plate for supplying oxidizer and fuel to the combustion chamber extend at an angle through the plate to produce a swirling or vortex action in the combustion chamber. In another embodiment the holes extend perpendicularly through the plate.

In the engine of the invention individually controlled auxiliary fuel supply tubes are connected with the fuel plate assembly, in addition to the main fuel supply, to supply more fuel to selected parts of the fuel plate manifold when desired for extra boost, and/or to supply different fuel or fuels.

The engine of the invention has an ignition system that directs a relatively small amount of fuel toward one or more igniters to initiate combustion, resulting in a “soft start” ignition system, rather than to completely fill the combustion chamber, throat and nozzle before igniting the fuel and oxidizer mixture as in conventional designs, a so-called “hard start” ignition system.

Additionally, the engine of the invention has multiple igniters to provide a redundant ignition in the event of failure of one igniter.

The engine of the invention also has one or more annular shoulders in the exhaust bell, facing axially outwardly thereof, to provide reaction surfaces for developing added thrust in the exhaust bell.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a side view in elevation of a rocket engine according to the invention, with four oxidizer tubes disposed at locations spaced 90° apart around the circumference of the engine, connected tangentially to the oxidizer ring at the open bottom end of the exhaust bell.

FIG. 2 is a top plan view of the engine of FIG. 1, with the fuel plate omitted for simplicity of illustration.

FIG. 3 is an enlarged view of the engine of FIG. 1, shown in longitudinal section on the left hand side of the figure and in elevation on the right hand side, with some parts omitted for the sake of clarity. It should be noted that for purposes of illustration the scale of the flow channels and ribs is exaggerated in relation to the skins. In actuality, the skins are much thicker in relation to the flow channels and ribs than shown in the drawings.

FIG. 4 is an enlarged fragmentary view in section of an upper left hand portion of the engine of FIG. 1, with redundant parts omitted for the sake of clarity. See the comment to FIG. 3.

FIG. 5 is an enlarged fragmentary view in section of a lower left hand portion of the engine of FIG. 1. See the comment to FIG. 3.

FIG. 6 is a fragmentary transverse sectional view taken along line 6-6 in FIG. 5, with the annular space between the skins and the reinforcing ribs exaggerated in scale relative to the thickness of the skins for purposes of clarity of illustration.

FIG. 7 is a side view in elevation of the engine of FIG. 1, with the outer skin, oxidizer tubes, and fuel plate assembly omitted to show the longitudinally extending reinforcing ribs.

FIG. 8 is a transverse sectional view taken along line 8-8 in FIG. 7.

FIG. 9 is a transverse sectional view taken along line 9-9 in FIG. 7.

FIG. 10 is an exploded view in side elevation of the fuel plate assembly of the invention, showing the spark holders, main fuel supply fitting, and auxiliary fuel supply tubes.

FIG. 11 is an assembled view in side elevation of the fuel plate assembly of FIG. 10.

FIG. 12 is a plan view of the fuel plate mounting flange used in the fuel plate assembly of the invention.

FIG. 13 is a plan view of the fuel plate cap used in the fuel plate assembly of the invention.

FIG. 14 is a plan view of the mounting ring used in assembling the fuel plate assembly to the upper end of the uni-body.

FIG. 15 is a plan view of a first form of fuel plate used in the fuel plate assembly of the invention.

FIG. 16 is a fragmentary perspective view of the lower end of one of the oxidizer tubes of the invention, showing the elliptical shape of the end of the tube for tangential attachment to the oxidizer ring, and showing a check valve that may be mounted in the oxidizer tube to prevent reverse flow through the tube.

FIG. 17 is an exploded bottom perspective view of the mounting flange, fuel plate, and fuel plate cap, with the inner and outer walls attached to the underside of the mounting flange.

FIG. 18 is a greatly enlarged fragmentary sectional view of the fuel plate, taken along line 18-18 in FIG. 17, and showing an embodiment in which the holes for flow of oxidizer through the plate are angularly disposed.

FIG. 19 is a greatly enlarged fragmentary sectional view of the fuel plate of FIG. 17, taken along line 19-19 in FIG. 17, showing the angular disposition of the holes for flow of fuel through the plate.

FIG. 20 is a top perspective view of an assembled fuel plate assembly according to one embodiment of the invention.

FIG. 21 is a bottom perspective view of the assembled fuel plate assembly of FIG. 20, showing the spark plug igniters in their operative position extended below the fuel plate.

FIG. 22 is a bottom plan view of the fuel plate assembly of FIGS. 20 and 21.

FIG. 23 is an enlarged bottom plan view of another embodiment of fuel plate according to the invention, showing the disposition of the fuel and oxidizer holes.

FIG. 24 is a side view in elevation of a rocket engine according to the invention wherein four oxidizer tubes are employed, as in the embodiment shown in plan view in FIG. 2.

FIG. 25 is a perspective view. of an engine according to the invention wherein only one oxidizer tube is employed.

FIG. 26 is a perspective view of an engine according to the invention wherein two oxidizer tubes are employed, as in the FIG. 1 embodiment.

FIG. 27 is a perspective view of an engine according to the invention wherein three oxidizer tubes are employed.

FIG. 28 is a perspective view of that embodiment of the engine shown in FIGS. 1 and 24, wherein four oxidizer tubes are employed.

FIG. 29 is a perspective view of an engine according to the invention wherein six oxidizer tubes are employed.

### DETAILED DESCRIPTION OF THE PREFERRED EMBODIMENTS

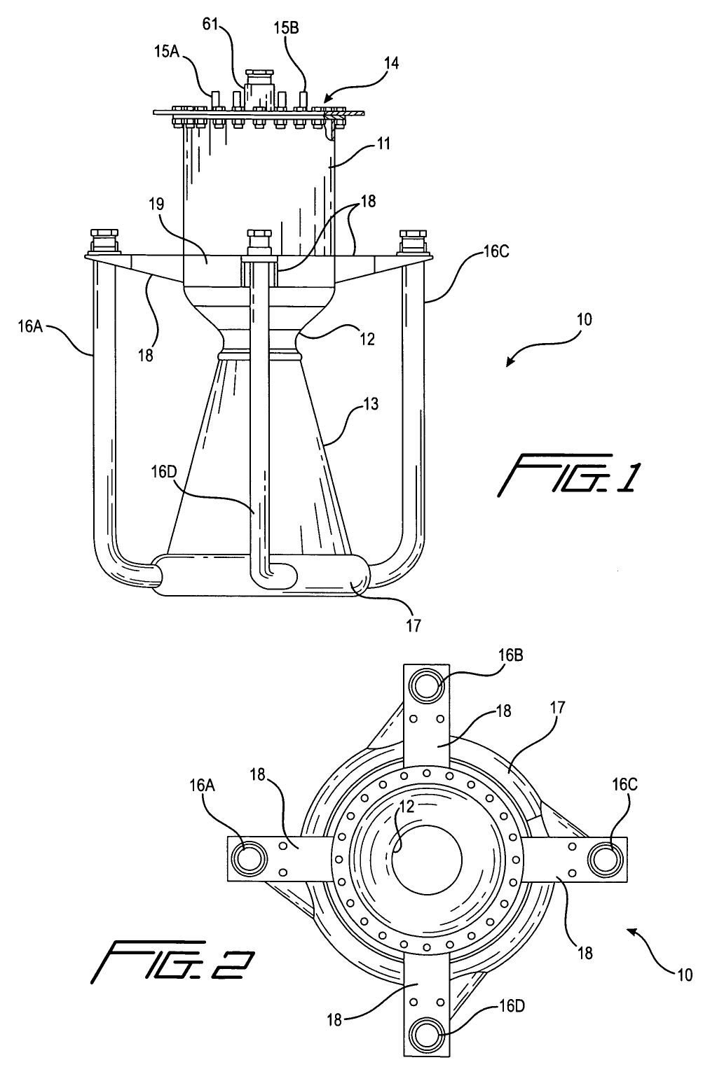

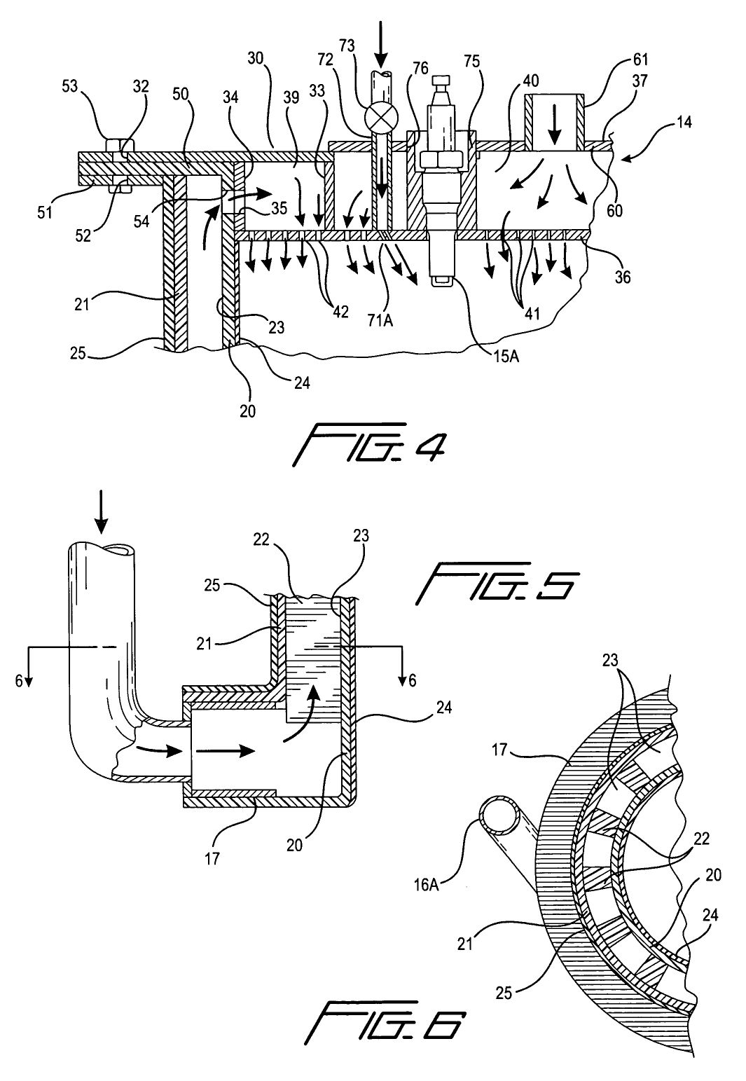

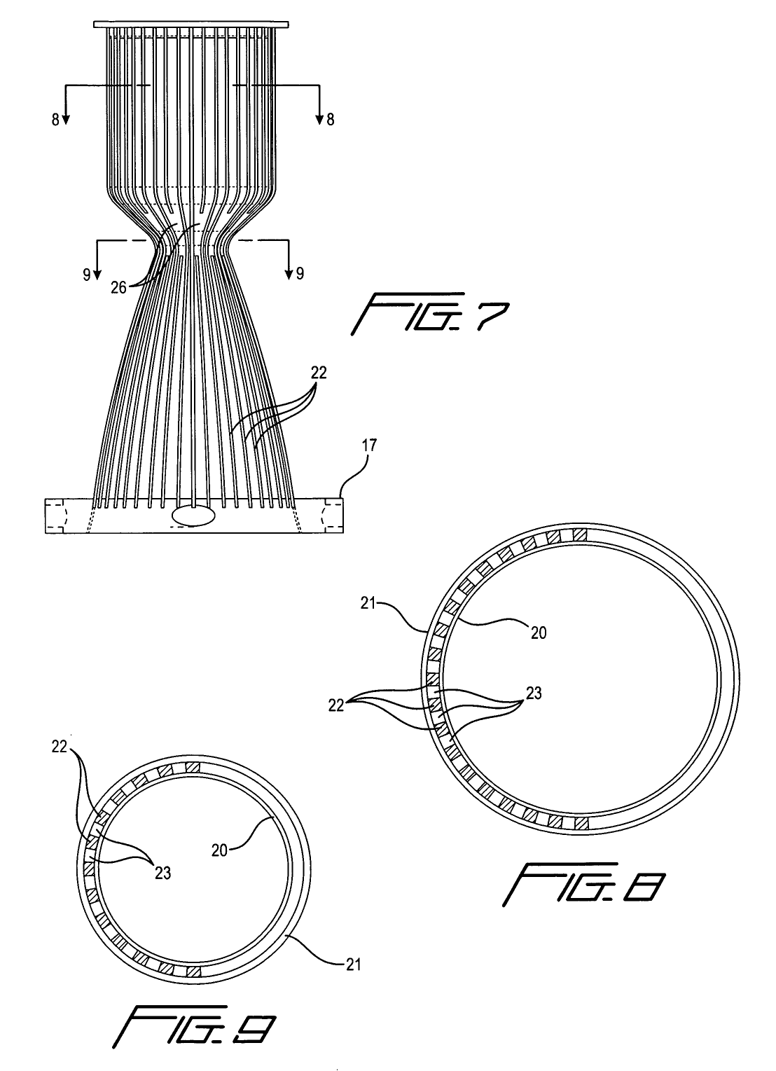

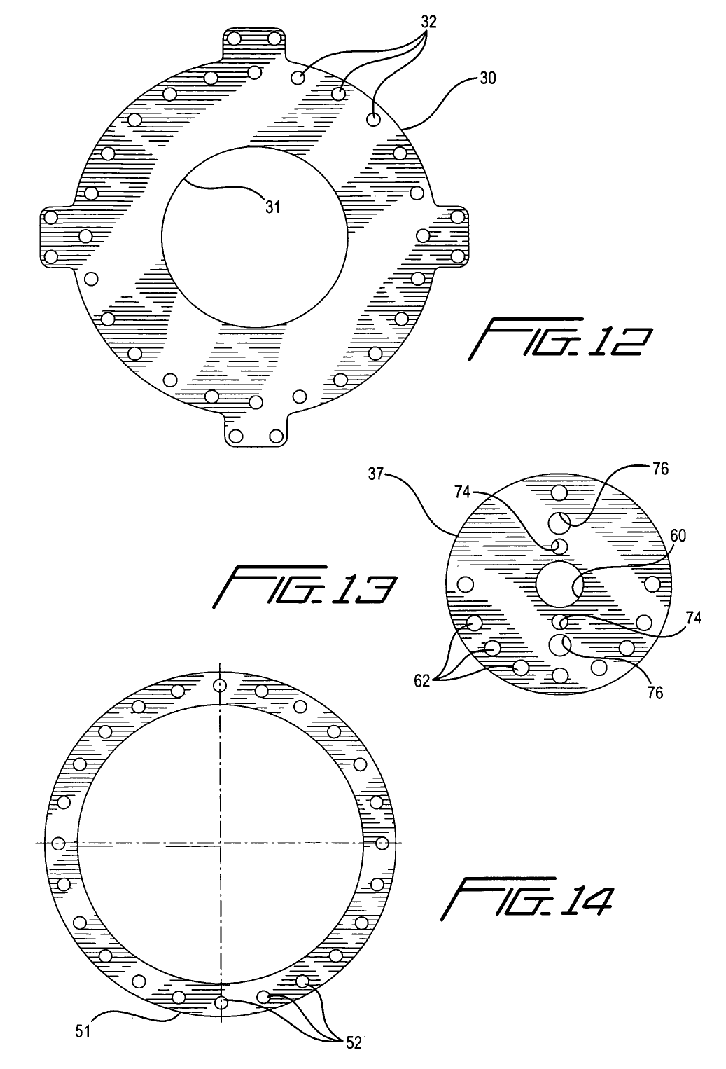

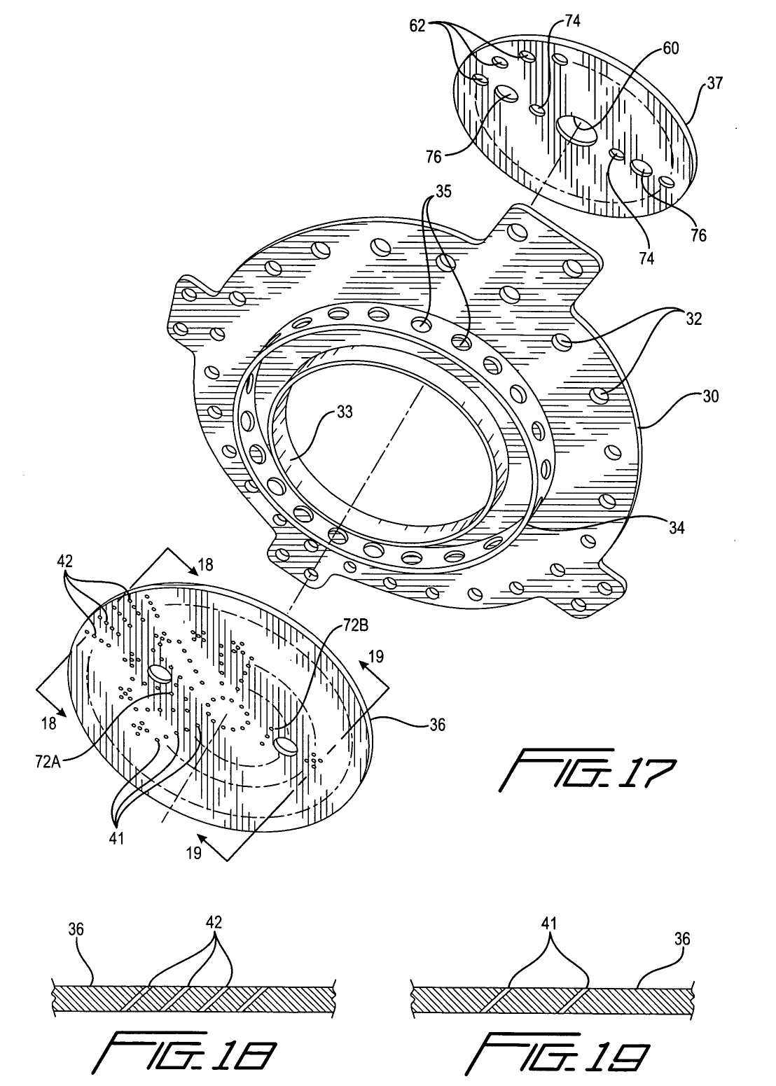

A first embodiment of rocket engine according to the invention is shown in FIGS. 1-21 and 28. As seen in FIG. 1, the engine 10 comprises a combustion chamber 11 of substantially cylindrical shape, a reduced diameter throat 12, and an outwardly flared exhaust bell or nozzle 13, forming a rocket engine body of substantially conventional shape but incorporating unique features as described hereinafter. A fuel plate assembly 14 is mounted to the upper end of the combustion chamber for supplying fuel and oxidizer to the combustion chamber, and igniters 15A and 15B extend through the fuel plate assembly and into the combustion chamber for igniting the fuel and oxidizer mixture. Four oxidizer tubes 16A, 16B, 16C and 16D are provided in this embodiment, extending longitudinally of the engine and connected tangentially at their lower ends to an oxidizer ring 17 on the bottom end of the exhaust bell, and connected at their upper ends to mounting brackets 18 that are in turn secured to a mounting band 19 fixed to the outside of the combustion chamber just above the throat. This arrangement not only permits supply of oxidizer to multiple points on the oxidizer ring, thereby obtaining more even distribution of the oxidizer around the ring and thence upwardly through the channels between the skins, as described more fully below, but also enables different oxidizers to be used, e.g. outside air and/or on-board oxidizer. This type of engine, i.e. with the oxidizer circulated through the skin of the engine, is referred to as regeneratively cooled.

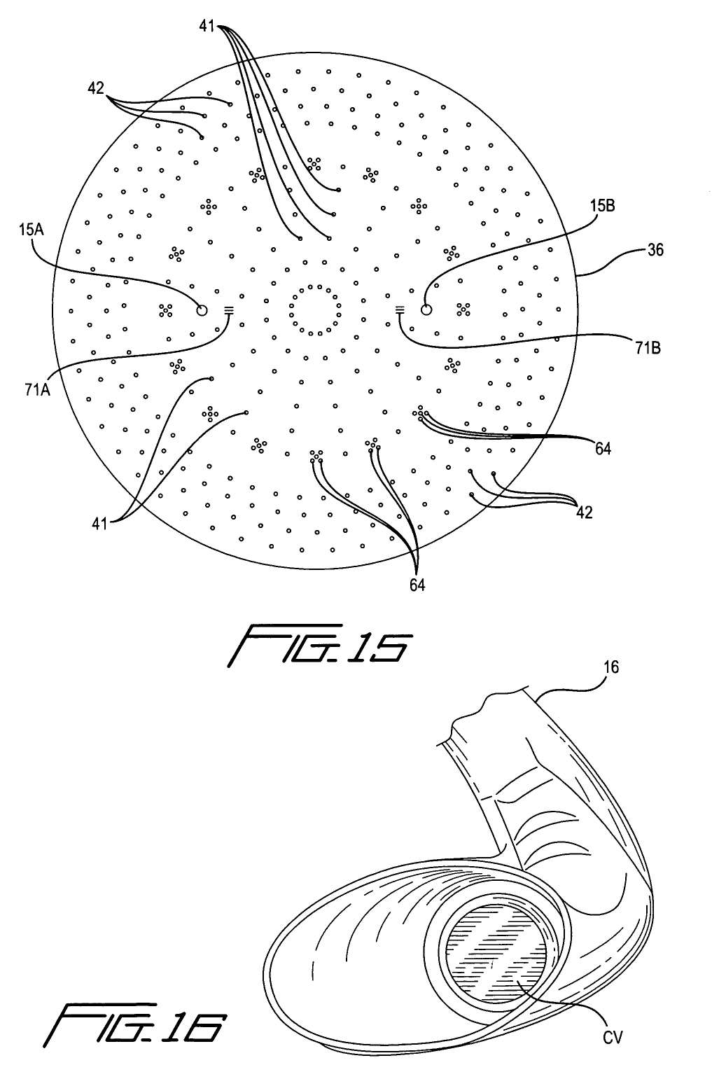

In the invention the oxidizer/coolant comes from tanks (not shown) of stored nitrous oxide or other suitable oxidizer, and/or from atmospheric air at lower altitudes, and in a preferred embodiment is supplied from the tanks through 2″ diameter pipes (not shown) and then enters the 3″ diameter oxidizer tubes 16A, 16B, 16C and 16D before entering the 4″ oxidizer ring 17. This progressively larger plumbing on the way to the engine promotes expansion of the gas from its stored liquid form into a gaseous form, causing cooling. As seen in FIG. 16, a check valve CV may be provided in the oxidizer tubes to prevent reverse flow.

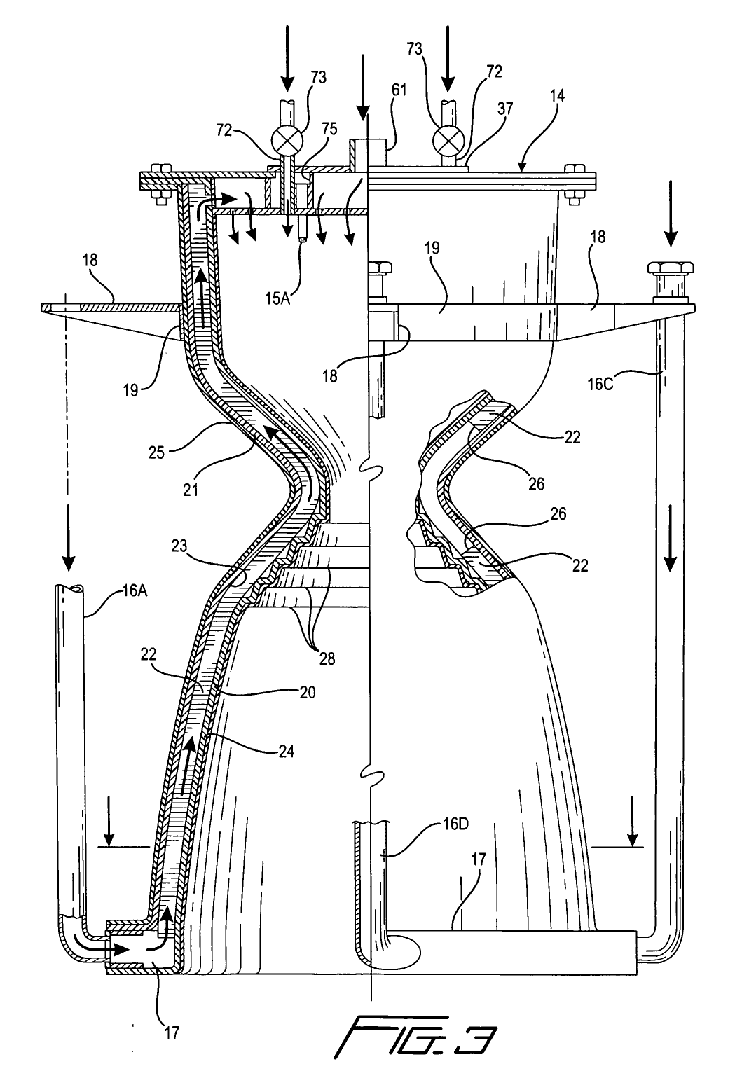

With particular reference to FIG. 3, the engine has a uni-body construction, comprising an inner skin 20 and a spaced outer skin 21, both extending continuously throughout the length of the engine, with a plurality of spaced apart ribs 22 extending between and bonded to the skins. The ribs reinforce the uni-body construction, and with the skins define a plurality of flow channels 23 for flow of oxidizer from the oxidizer ring to the fuel plate assembly. As the oxidizer flows through the channels it has a cooling effect on the walls of the exhaust bell, throat and combustion chamber of the engine. In the particular example shown there are forty square ceramic rope ribs 22 that give great strength vertically and provide even spacing between the skins top to bottom to make forty coolant channels 23. It should be noted that for purposes of illustration the scale of the flow channels and ribs is exaggerated in relation to the skins. In actuality, the skins are much thicker in relation to the flow channels and ribs than shown in the drawings.

In a preferred construction, both the inner and outer skins 20 and 21 are made of fiber reinforced composites, comprising plural layers of carbon fiber fabric such as Panex SWB-8, a high modulus-strength carbon fiber fabric available from Zoltek Corporation of Bridgeton, Mo., bonded with a phenolic resin. The ribs 22 comprise a ceramic fiber braid, square in cross-section, sold under part number IN001075 by Graphitestore.com, and bonded to the skins by Resbond 989 high temperature adhesive sold by Cotronics Corporation of Brooklyn, N.Y.

The inner surface of the inner skin is coated with a layer 24 of high temperature graphite, also sold by Graphitestore.com, under the name Graphi-Bond 551RN Graphite Adhesive (part number AR001810). This layer provides extra strength and helps protect the skins from the high temperatures in the combustion chamber, throat, and exhaust bell.

A reinforcing layer 25 of Kevlar/Carbon Hybrid fabric, sold by Fibre Glast Developments Corporation of Brookville, Ohio, under part number 1065 or 1066 or 1067, depending upon the color selected, is applied to the outer surface of the outer skin. It should be noted that the term “layer” is intended to cover multiple plies of Kevlar/Carbon Hybrid fabric.

With particular reference to FIGS. 3 and 7-9, it can be seen that some of the ribs 22 are interrupted at 26 so that they do not extend across the throat. Otherwise, the ribs would be too close together in this reduced diameter area, restricting flow of the oxidizer. However, many of the ribs extend continuously from one end of the engine to the other, providing continuous reinforcement over the length of the engine.

The inner surface of the inner skin 20 in the exhaust bell 13 may be formed with one or more annular, outwardly facing reaction shoulders 28 near the throat. As the gases from the combustion chamber push through the throat and expand, these shoulders form circular ledges in the side wall of the exhaust bell for the expanding gases to push against, increasing thrust.

As seen best in FIGS. 10-21, the fuel plate assembly 14 comprises a fuel plate mounting flange 30 with a large central opening 31 and a plurality of evenly circumferentially spaced small holes 32 around the outer margin. A first, non-perforated annular wall 33 is welded or otherwise suitably secured in the opening 31 and extends downwardly from the underside of the plate. A second annular wall 34 with a plurality of evenly spaced openings 35 therethrough is welded or otherwise suitably affixed to the bottom of the fuel plate mounting flange in radially outwardly spaced relationship to the non-perforated wall 33. The number and locations of the openings 35 correspond to the number and locations of the flow channels 23 defined by the inner and outer skins 20, 21 and the ribs 22.

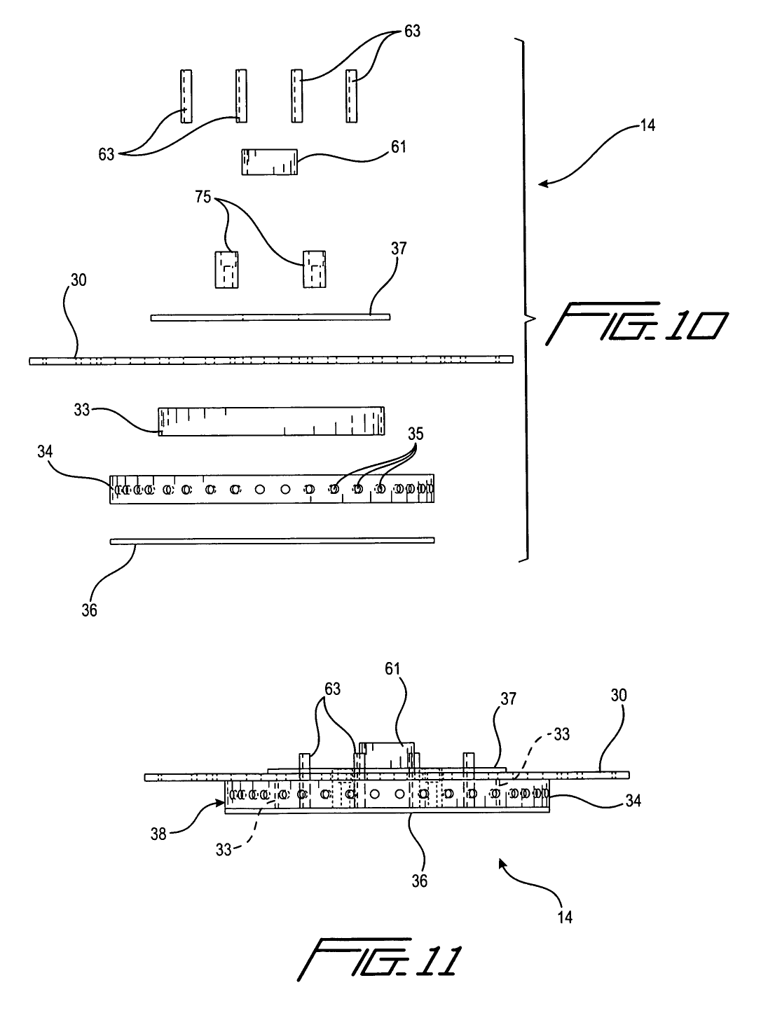

A fuel plate 36 is welded or otherwise suitably affixed to the bottom edges of the walls 33 and 34, and a fuel plate cap 37 is welded over the opening 31 on the side of the mounting flange 30 opposite the side to which the walls 33 and 34 are affixed. These components define a fuel plate manifold 38 on the underside of the mounting flange (see FIG. 11), with an annular outer oxidizer chamber 39 and a central fuel chamber 40 isolated from the oxidizer chamber by the imperforate wall 33 (see FIG. 4).

The fuel plate 36 has a plurality of substantially evenly distributed fuel holes 41 therethrough over a central portion of the fuel plate located within the space bounded by wall 33, and a plurality of oxidizer holes 42 extending through the annular portion of the fuel plate that lies between the walls 33 and 34. In a preferred embodiment the holes 41 and 42 are angularly disposed to impart a swirling motion to the fuel and oxidizer in the combustion chamber. In specific examples of the invention, the holes 41 and 42 may be drilled at a consistent clockwise or counter-clockwise 45° angle, or a 22° angle, or perpendicular to the plate, or at any other desired angle.

As seen best in FIG. 4, the upper end of the inner skin 20 is turned outwardly, defining a radially outwardly extending flange 50. When the fuel plate assembly 14 is affixed to the upper end of the engine, the outer annular portion of the mounting flange that extends beyond the outer perforate wall 34 lies over and is bonded to the flange 50. An annular mounting ring 51 with a plurality of holes 52 therethrough is positioned beneath the flange 50, with the holes 52 in aligned registry with the holes 32 in the mounting flange, and bolts or other suitable fasteners 53 are extended through the holes to secure the parts together with the carbon fiber flange 50 sandwiched between the mounting flange and the mounting ring. The fuel plate assembly and the mounting ring preferably are made of stainless steel, although other suitable material could be used.

When the fuel plate assembly is mounted to the engine, the fuel plate manifold 38 extends into the upper end of the combustion chamber, with the perforate wall 34 lying close against the inner surface of the inner skin, and with the holes 35 in wall 34 in aligned registry with corresponding holes 54 in the upper end of the inner skin. The holes 54, in turn, are in aligned registry with respective channels 23. The oxidizer thus flows through the side of the combustion chamber and into the oxidizer chamber portion of the fuel plate manifold. With further reference to FIG. 4, it will be noted that the flange 50 and outer marginal portion of the fuel plate assembly close the upper ends of the channels 23.

As seen best in FIG. 5, the lower end of the inner skin 20 is turned outwardly to define a flange 55 that extends beneath and is bonded to the underside of the oxidizer ring 17. Similarly, the lower end of the outer skin 21 is turned outwardly to form a flange 56 that extends over the top of the oxidizer ring and is bonded thereto. It will be noted that the radially inner side of the oxidizer ring is completely open to the flow channels 23, and the ribs 22 extend partially past the upper edge of the oxidizer ring but terminate short of the bottom of the exhaust bell.

The fuel plate cap 37 has a central opening 60 therein for attachment of a fitting 61 for connection to a main fuel supply (not shown), and in a preferred embodiment of the invention a plurality of holes 62 are spaced circumferentially around the cap for receiving auxiliary fuel supply tubes 63 to supply a different or additional fuel to the engine. The tubes 63 extend through the cap 37 and fuel chamber 40 and terminate against the fuel plate 36, which has small openings 64 therethrough in aligned registry with the respective tubes. In a preferred embodiment the openings 64 are angularly oriented so that the fuel enters the combustion chamber with a swirling motion, promoting thorough mixing and combustion of the fuel and oxidizer. Further, as seen in FIG. 15, more than one opening 64 may be associated with each tube. As shown in this figure there are five openings associated with each tube.

In the specific example shown in FIGS. 13, 15, 17 and 20, there are sixteen auxiliary fuel supply tubes 63, and a flow control valve (not shown) may be associated with each individual tube (see FIG. 4), or with groups of tubes, to control flow of fuel through the tubes so that a different fuel can be supplied through these tubes than is supplied through the main fuel supply, or additional fuel can be supplied to increase thrust, etc. The fuel supply tubes 63 and their associated valves are referred to herein as a turbo booster steering system, i.e. if fuel flows through all sixteen tubes simultaneously, then a straight forward boost would be felt, but it is believed that if fuel is supplied to just one tube, or to a group of tubes in one segment of the fuel plate, then extra thrust would result on that side, encouraging a turn without any moving parts. For example, fuel flowing through one, two, four or eight tubes would surge more fuel to 1/16, ¼, or ½, respectively, of the inside of the combustion chamber, and it is believed this will create various amounts of uneven thrust, effecting a turn.

The use of auxiliary fuel supply in addition to the main fuel supply makes the engine a multi-fuel hybrid since it can use one fuel, e.g. propane, kerosene, or other fuel, in its main center fuel port and another fuel, e.g. propane, kerosene, or other fuel, in its turbo booster ports.

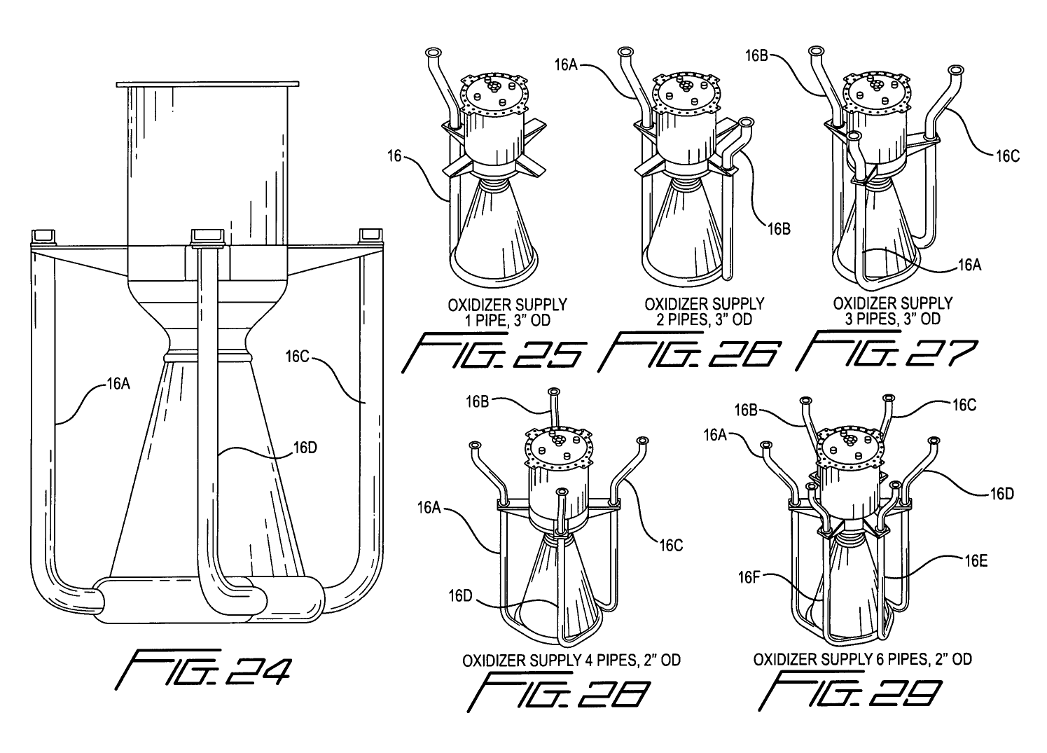

Further, because of the use of multiple oxidizer tubes the engine of the invention is also a multi-oxidizer hybrid since it can use outside air, nitrous oxide, or liquid oxygen (LOX), or other suitable oxidizer, or a combination of these. In the embodiment shown in FIGS. 1 and 2, four oxidizer tubes are employed, but one could be used as indicated at 16 in FIG. 25, or two could be used as indicated at 16A and 16B in FIG. 26, or three could be used as indicated at 16A, 16B and 16C in FIG. 27, or six could be used as indicated at 16A, 16B, 16C, 16D, 16E and 16F in FIG. 29. The use of four tubes is shown in FIGS. 1,2,24 and 28, at 16A, 16B, 16C and 16D.

The engine of the invention also has a soft start ignition that ignites the fuel and oxidizer mixture immediately upon its entry into the combustion chamber and before a large quantity of this explosive mixture can accumulate in the engine. The soft start ignition, so-called because it does not cause a large, violent explosion when the fuel and oxidizer mixture is first ignited, comprises two igniters 15A and 15B and associated ignition fuel ports 71A and 71B, respectively, closely adjacent to the igniters, all carried by the fuel plate assembly 14. The ignition fuel ports 71A and 71B are angled toward the respective adjacent igniters to direct fuel toward the igniters so that ignition can occur immediately rather than having to let the fuel and oxidizer accumulate in the combustion chamber until it reaches the igniters in sufficient concentration to be ignited.

In the example shown in FIGS. 4 and 15 the ignition fuel ports each comprise three closely spaced holes drilled diagonally through the fuel plate to emit fuel, e.g. propane, from a low pressure ignition fuel supply tube 72 extending through opening 74 in the fuel plate cap 37 and through the fuel chamber 40 and welded to the backside of the fuel plate 36. Flow of ignition fuel is controlled by valves 73. In a preferred construction, the propane (or other fuel) is aimed from one inch away at a 45° angle to hit the tip of the igniter 15A or 15B, which in the preferred embodiment comprise an Autolite Revolution HT® spark plug.

The tip of this spark plug has a double armature and it protrudes one inch into the combustion chamber. Holders 75 for the spark plugs extend through holes 76 in the fuel plate cap and through the fuel chamber 40 and are welded to the fuel plate.

It will be noted that two igniters and associated ignition fuel ports are provided. This is a redundant system for safety, but only one igniter and associated ignition fuel supply port could be used if desired.

In the specific example of the first embodiment shown in the drawings, there are ninety-six substantially evenly distributed fuel holes 41 extending through the central portion of the fuel plate, two hundred substantially evenly distributed oxidizer holes 42 in the annular outer portion of the plate, and sixteen groups of five fuel holes 64 in the ring of turbo booster ports. The two ignition fuel ports 71A and 71B each comprise three angularly disposed holes adjacent the igniters.

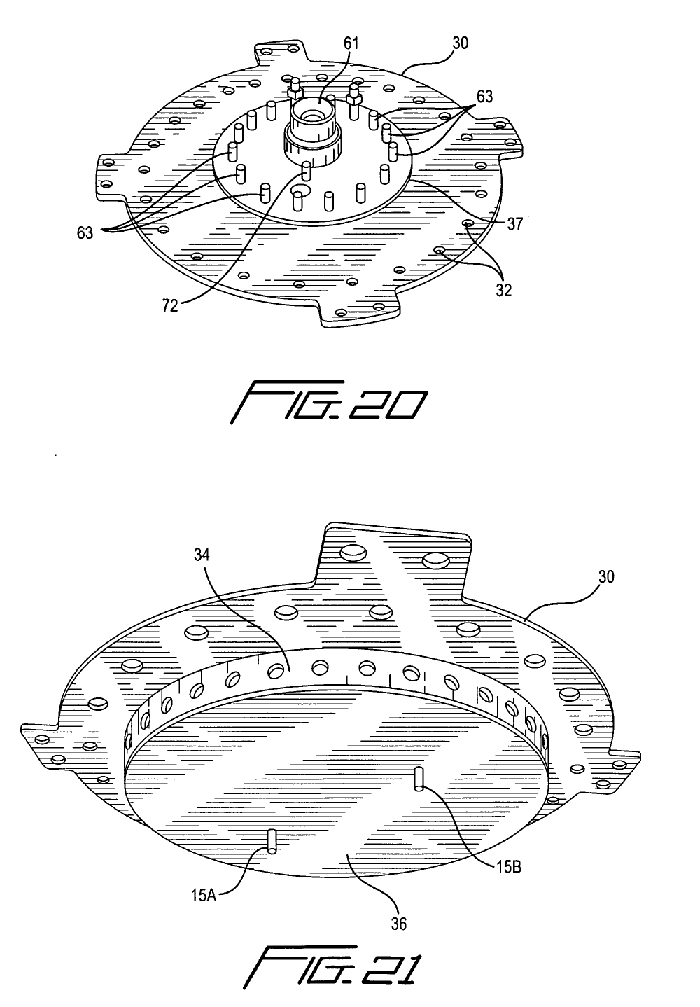

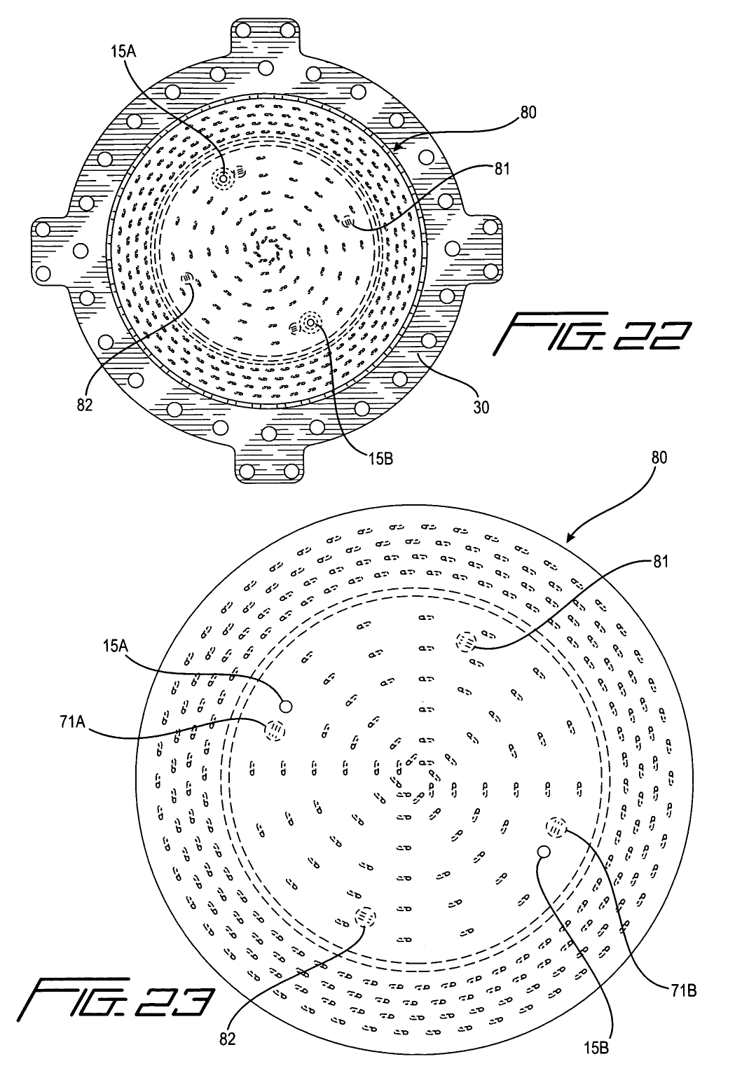

An alternate embodiment of fuel plate 80 is shown in FIGS. 22 and 23. In this embodiment the sixteen auxiliary fuel ports and their associated parts are omitted and two diametrically opposed auxiliary ports 81 and 82 are used instead. In the specific example shown, each of the ports 81 and 82 comprises three closely spaced, angularly oriented holes. In all other respects this form of the invention is the same as the form described above.

Although particular embodiments of the invention are illustrated and described in detail herein, it is to be understood that various changes and modifications may be made to the invention without departing from the spirit and intent of the invention as defined by the scope of the appended claims.

What is claimed is:

1. a rocket engine having a combustion chamber, a throat, and an exhaust bell that together form an engine body, wherein:
the engine body is of uni-body construction, with the combustion chamber, throat, and exhaust bell all unitarily formed as one piece from composite material.

2. A rocket engine as claimed in claim 1, wherein:
the engine body comprises spaced apart inner and outer skins, with a plurality of spaced apart longitudinally extending ribs between the skins dividing the space between the skins into flow channels for circulation of a coolant.

3. A rocket engine as claimed in claim 2, wherein:
the inner and outer skins comprise a carbon fiber fabric material.

4. A rocket engine as claimed in claim 3, wherein:
a reinforcing and insulating layer of graphite material is coated on the inner surface of the inner skin.

5. A rocket engine as claimed in claim 4, wherein:
a reinforcing layer of Kevlar/carbon fiber material is applied to the outer surface of the outer skin.

6. A rocket engine as claimed in claim 5, wherein:
the ribs comprise a braided ceramic material.

7. A rocket engine as claimed in claim 2, wherein:
the exhaust bell has an exit end, and an oxidizer ring is attached to the exit end in encircling relationship thereto, said oxidizer ring being in fluid flow communication with the flow channels between the skins;
at least one oxidizer tube for connection between a supply of oxidizer and the oxidizer ring extends longitudinally of the engine in spaced relationship thereto, said at least one oxidizer tube being tangentially connected at one end to the oxidizer ring for supply of oxidizer through the ring and into the flow channels, said flow channels being in fluid flow communication with the combustion chamber so that oxidizer flows through said at least one oxidizer tube, through said oxidizer ring, and through said flow channels, whereby the rocket engine is regeneratively cooled; and
said at least one oxidizer tube is connected at its other end to the combustion chamber, in spanning relationship to the throat, whereby the at least one oxidizer tube serves not only to supply oxidizer to the engine but also reinforces the engine.

8. A rocket engine as claimed in claim 7, wherein:
the inner and outer skins comprise a carbon fiber fabric material.

9. A rocket engine as claimed in claim 8, wherein:
a reinforcing and insulating layer of graphite material is coated on the inner surface of the inner skin.

10. A rocket engine as claimed in claim 9, wherein:
a reinforcing layer of Kevlar/carbon fiber material is applied to the outer surface of the outer skin.

11. A rocket engine as claimed in claim 10, wherein:
the ribs comprise a braided ceramic material.

12. A rocket engine as claimed in claim 7, wherein:
there are a plurality of oxidizer tubes connected with said oxidizer ring at spaced locations around said oxidizer ring for more effective distribution of oxidizer into the flow channels.

13. A rocket engine having a combustion chamber, a throat, and an exhaust bell, wherein:
a fuel plate assembly is mounted on an inlet end of said combustion chamber, said fuel plate assembly comprising:
a fuel plate mounting flange having a large central opening therethrough and a marginal edge portion with a plurality of spaced holes therethrough;
a first, imperforate annular wall affixed to an underside of said mounting flange at the edge of said central opening;
a second annular wall affixed to an underside of said mounting flange in radially outwardly spaced relation to said first annular wall, said second annular wall having the same height as said first annular wall and having a plurality of openings therethrough;
a fuel plate extending across and fixed to the bottom edges of said first and second annular walls, said fuel plate having the same diameter as said second annular wall and having a plurality of openings therethrough; and
a fuel plate cap fixed to a top surface of said mounting flange in spanning relationship to said central opening, and with said mounting flange, said first and second annular walls, and said fuel plate, defining an enclosed space that is divided by said first annular wall into a central fuel chamber and an annular oxidizer chamber, said annular oxidizer chamber located between the first and second annular walls;
said mounting flange, said first and second annular walls, and said fuel plate defining a fuel plate manifold, said fuel plate manifold extending into an upper end of the combustion chamber.

14. A rocket engine as claimed in claim 13, wherein:
a first group of said plurality of openings through said fuel plate communicate with said oxidizer chamber, and a second group of said plurality of openings communicate with said fuel chamber.

15. A rocket engine as claimed in claim 14, wherein:
said plurality of openings extend at an angle through said fuel plate, whereby a swirling motion is imparted to fuel and oxidizer flowing therethrough.

16. A rocket engine as claimed in claim 15, wherein:
said combustion chamber, throat, and exhaust bell are double-skinned, comprising an inner skin and an outer skin spaced therefrom;
a plurality of ribs extend longitudinally between the inner and outer skins, dividing the space between the skins into a plurality of flow channels;
means connected with said flow channels at a bottom end of said exhaust bell to supply oxidizer thereto; and
openings in the side of said combustion chamber at an upper end thereof, said openings being in communication with the flow channels and with the openings through said second annular wall forming a part of said fuel plate manifold, whereby oxidizer flows through the sides of the combustion chamber into the oxidizer chamber and thence into the combustion chamber.

17. A rocket engine having a combustion chamber and an exhaust nozzle, wherein the improvement comprises:
a fuel plate assembly having means defining a fuel plate manifold disposed in an upper end of the combustion chamber, said fuel plate manifold including a fuel plate disposed in the combustion chamber and having a plurality of holes therethrough for flow of fuel and oxidizer into the combustion chamber;
means for connecting sources of fuel and oxidizer with the fuel plate manifold; and
soft start ignition means for igniting fuel and oxidizer mixture in the combustion chamber, said soft start ignition means comprising:
igniter means in the combustion chamber for igniting fuel and oxidizer mixture in the combustion chamber; and
at least one ignition fuel hole through the fuel plate adjacent the igniter means and angled to direct fuel toward the igniter means so that the fuel is ignited as soon as it enters the combustion chamber, enabling ignition before said combustion chamber fills with fuel and oxidizer mixture.

18. A rocket engine as claimed in claim 17, wherein:
the igniter means includes multiple igniters to provide a redundant ignition system to ensure ignition in the event of failure of one of the igniters.

19. A rocket engine as claimed in claim 18, wherein:
said at least one ignition fuel hole comprises a plurality of holes associated with each igniter.
